(19) United States
(12) Patent Application Publication
(10) Pub. No.: US 2026/0303443 A1
(43) Pub. Date: Oct. 1, 2026

(54) SYSTEMS AND METHODS FOR FAILOVER AND RECOVERY OF DISTRIBUTED INTERNET SERVICES

(71) Applicant: 8x8, Inc., Campbell, CA (US)

(72) Inventor: Michael E. Laws, Atascadero, CA (US)

(73) Assignee: 8x8, Inc., Campbell, CA (US)

(21) Appl. No.: 19/096,590

(22) Filed: Mar. 31, 2025

(51) Int. Cl. H04L 41/0663; H04L 45/00; H04L 61/4511

(52) U.S. Cl. CPC H04L 41/0663; H04L 45/38; H04L 61/4511

(57) ABSTRACT

A system configured to implement a service switching includes: a PSV processing unit configured to communicate with a data base; the data base storing a preconfigured-selectable-values (PSV) record, wherein the PSV record comprises a first IP identifier associated with a first service provider, a second IP identifier associated with a second service provider, and an active service provider identifier that indicates a selected service provider; wherein the PSV processing unit is configured to access the database to retrieve the PSV record, to change the active service provider identifier to indicate the other one of the first service provider and the second service provider as a newly selected service provider, to process the PSV record to create a DNS record, and to provide the created DNS record to cause network traffic data to be routed to the newly selected service provider.

### FIELD

The field of the subject disclosure relates to Domain Name System (DNS) systems, management of DNS records, and systems and methods for failover and disaster recovery of distributed Internet services involving DNS.

### BACKGROUND

In large-scale distributed applications and Internet services, Domain Name System (DNS) is utilized to direct end-users to the systems and infrastructure that host such applications and services. DNS records associate human-readable names (e.g., www.google.com) to numeric IP addresses, which are useful in network routing. These numeric IP addresses are routed to a single physical location hosting the applications and services.

Sometimes, in an event of a failure of the infrastructure or service, it is a common operational practice to maintain a failover or disaster recovery (DR) infrastructure at a discrete physical site with discrete IP addresses in order to minimize the impact of the failure. In the failure cases, DNS records need to be updated to reflect the change in IP addresses at the new failover or DR location.

In large-scale systems (such as contact service systems) composed of many interoperating services (e.g., microservices), the DNS records utilized to facilitate normal service-to-service operation may easily grow into a large number, such as hundreds of DNS records. Such large number of DNS records makes implementation and coordination of a failover or DR event time consuming, error-prone, resource intensive, and unnecessarily impactful to the services involved.

### SUMMARY

Systems and methods for management of DNS, and for implementing service-switching involving DNS-driven mechanisms are described herein. In one example, the systems and methods may be utilized to implement failover and disaster recovery of distributed Internet services involving DNS. In another example, the systems and methods may be utilized to configure routing of network traffic to and/or from data center(s). In some embodiments, the systems and methods involve use of a preconfigured-selectable-values (PSV) record, which is a custom configuration construct that enables multiple named configurations (options) to be preconfigured (e.g., pre-determined) and be associated with a DNS record. The PSV record may be updated to select one of the pre-configured options, and may be processed by a PSV processing unit to render a DNS record, thereby implementing the service-switching. In one example of the PSV processing unit described herein, the PSV processing unit includes a translator configured to translate a PSV record, and a renderer configured to create a DNS record based on a PSV record. Each PSV record may include one or more tags (e.g., free-form tag(s)), which allow context-based searching of the PSV record. An example of the system described herein includes a PSV manager that enables creation, searching, and updating of PSV records. In some embodiments, the PSV manager includes a user interface generator configured to provide a user interface to allow a user to create, search, and update PSV records.

A system configured to implement a service switching between a first service provider and a second service provider, the system includes a PSV processing unit configured to communicate with a database; the data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider; wherein the processing unit is configured to access the database to retrieve the PSV record; wherein the PSV processing unit is configured to change the active service provider identifier to indicate the other one of the first service provider and the second service provider as a newly selected service provider; wherein the PSV processing unit is configured to, after changing the active service provider identifier in the PSV record, process the PSV record to create a DNS record, and to provide the created DNS record to cause network traffic data to be routed to the newly selected service provider by a network traffic infrastructure according to the created DNS record.

Optionally, the created the DNS record is based on the changed active service provider identifier in the PSV record.

Optionally, the PSV processing unit is configured to create the DNS record by translating the PSV record, and rendering the translated PSV record.

Optionally, the PSV processing unit is configured to process the PSV record to create the DNS record to implement the service switching when there is a failure of one of the first and second service providers.

Optionally, the PSV processing unit is configured to process the PSV record to create the DNS record to implement the service switching in response to a scheduled service switching.

Optionally, the PSV processing unit is configured to process the PSV record to create the DNS record to implement the service switching when a predicted network traffic condition meets a criterion.

Optionally, the PSV processing unit is configured to process the PSV record to create the DNS record to implement the service switching when an actual network traffic condition meets a criterion.

Optionally, the PSV record further comprises one or more tags, and wherein the PSV processing unit is configured to search for the PSV record using the one or more tags of the PSV record.

Optionally, the PSV record is one of a plurality of PSV records stored in the PSV database, and wherein the PSV processing unit is configured to search the PSV database to identify one or more of the PSV records with respective tag(s) that match a search criterion.

Optionally, the one or more of the PSV records comprises multiple ones of the PSV records having respective tags matching the search criterion, the multiple ones of the PSV records having respective active service provider identifiers, and wherein the PSV processing unit is configured to change the respective active service provider identifiers of the multiple ones of the PSV records in one batch.

Optionally, the PSV record further comprises a meta-type identifier.

Optionally, the meta-type identifier comprises an A-multi type indicating that the PSV record has multiple DNS IPv4 records, an AAAA-multi type indicating that the PSV record has multiple IPv6 records, a CNAME-multi type indicating that the PSV record has multiple DNS CNAME records, or a SRV-multi type indicating that the PSV record has multiple DNS SRV records.

Optionally, the PSV record further comprises a time-to-live (TTL) value.

Optionally, the PSV processing unit comprises logic that cooperate with a data structure of the PSV record.

Optionally, the system is integrated with a contact center, or is configured to communicate with the contact center.

Optionally, the PSV processing unit comprises a PSV configurator configured to provide a user interface that allows a user of the system to create the PSV record.

Optionally, the PSV processing unit comprises a PSV manager configured to allow a user of the system to manage the PSV record.

Optionally, the PSV record comprises one or more tags to provide a context to influence an artificial intelligence (AI) driven workflow.

Optionally, the PSV record is configured to implement a vendor-agnostic DNS configuration.

A method to implement service switching between a first service provider and a second service provider, includes: accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider; changing, by a PSV processing unit, the active service provider identifier to indicate the other one of the first service provider and the second service provider as a newly selected service provider; after the active service provider identifier is changed by the PSV processing unit, creating, by the PSV processing unit, a DNS record based on the PSV record; and providing the created DNS record to cause network traffic data to be routed to the newly selected service provider by a network traffic infrastructure according to the created DNS record.

Other and further aspects and features will be evident from reading the following detailed description.

### BRIEF DESCRIPTION OF THE DRAWINGS

The drawings illustrate the design and utility of embodiments, in which similar elements are referred to by common reference numerals. In order to better appreciate how advantages and objects are obtained, a more particular description of the embodiments will be described with reference to the accompanying drawings. Understanding that these drawings depict only exemplary embodiments and are not therefore to be considered limiting in the scope of the claimed invention.

FIG. 1 illustrates an example of a communication system having a contact center, which includes a service-switching system.

FIG. 2 illustrates an example or the service-switching system of FIG. 1.

FIG. 3A illustrates an example of a PSV record, and an example of a translated record based on the PSV record.

FIG. 3B illustrates a translation of a PSV record into a translated record, and a rendering of the translated record into a DNS record.

FIG. 4 illustrates another example of a PSV record.

FIG. 5 illustrates examples of rendered DNS records.

FIGS. 6A-6D illustrate examples of a user interface provided by the service-switching system of FIG. 1.

FIG. 7 illustrates a method in accordance with some embodiments.

FIG. 8 illustrates a variation of the communication system of FIG. 1, particularly showing the communication system having a neural network model.

FIG. 9 illustrates a specialized processing system in accordance with some embodiments.

### DESCRIPTION OF THE EMBODIMENTS

Various embodiments are described hereinafter with reference to the figures. It should be noted that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages of the invention shown. An aspect or an advantage described in conjunction with a particular embodiment is not necessarily limited to that embodiment and can be practiced in any other embodiments even if not so illustrated or if not so explicitly described.

System and method of implementing service switching are described herein. In some cases, the service switching may be performed in implement a failover or disaster recovery. In other cases, the service switching may be performed when a service switching criterion is met. In some cases, the system and method described herein may be utilized to implement changes of many DNS records through a DNS record translation tool, which implements preconfigured selectable values (PSVs) for each DNS Meta-Type, and uses the resulting “Rendered DNS records” to configure one or more DNS records on standard DNS infrastructure.

PSVs are novel “DNS Meta-Records” containing one or more named configuration options associated with a “DNS Meta-Type”, an “active” PSV (the active selection), and one or more “Free-form Tags”, that may be switched on a record-by-record basis, or en masse over a large number of DNS Meta-Records” (leveraging the free-fom tags to aid in determining the specific “DNS Meta-Records” to be switched en masse). This technique allows service developers to pre-configure failover and disaster recovery configurations as PSVs, and enable fast, easy, and reliable DNS changes across one or many DNS records to facilitate a failover or disaster recovery.

The system and method described herein are not limited to implementing failover and disaster recovery, and may be utilized in other situations that involve change of DNS for one or more Internet services. For example, in some cases, the system and method describe herein may be utilized to configure a routing of network traffic data to and/or from a data center.

The system and method described herein are advantageous over other methods of accomplishing large-scale DNS update across multiple Internet services. In particular, the system and method described herein provide faster, more efficient, and less resource-intensive (e.g., required manpower) to implement failover and disaster recovery compared to the technique of manually updating the DNS individually during a failover. Such manual updating is time-consuming, resource intensive, error-prone, and difficult to test and validate. In some cases, a service developer may individually script DNS updates required for each impacted service, which may provide some automation. However, such technique is also difficult to test, time-consuming, error prone, and resource intensive compared to the system and method described herein.

The system and method described herein may include one or more of the below aspects: (1) PSV record having preconfigured selectable values representing different pre-determined alternative service configurations; (2) PSV record having tag(s) that allow searching of the PSV record based on user-defined search criterion; (3) PSV processing unit configured to process PSV records to create DNS records to implement of a switching of a service configuration; or (4) PSV manager configured to allow creation, management, and updating of PSV records.

The selectable values in the PSV records are advantageous because they allow service developers to effectively “stage” their changes for testing, allowing for repeatability and testability. Also, the preconfigured selectable values in the PSV records, when leveraging with the tags in the PSV records, enable a single operator to initiate a staged change of many DNS records associated with a failover or disaster recovery, thereby reducing the coordination impact, mean time to recovery, and resources needed in a failover or disaster recovery event. In some cases, by leveraging proper use of the tags in the PSV records, the DNS configuration of many discrete services and applications impacted by an infrastructure failure can be updated in a single event, minimizing mean time to recovery.

Non-limiting examples of the present disclosure may be implementable as processing improvements for stand-alone applications or services, which can also be integrated into software computing platforms (“software platforms”). As software data platforms have layers of complexity, technical problems identified herein can be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8x8 Work^{®} made available by 8x8, Inc. (e.g., additional supporting documentation available at http://www.8x8.com), among other examples.

An exemplary software communications platform may include any technology described herein as “cloud-based platform implementation” individually or collectively. In one example, an exemplary software communications platform may comprise but is not limited to a combination of UCaaS, CPaaS, CPaaS features and functionalities, web services, and connected websites, administrative portals/consoles, connected to system infrastructure including phone systems hosted remotely by servers and accessible via the internet. An exemplary software communications platform can uniquely generate and manage contextual data from components and users thereof, which can then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but can also be represented in via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of technical advantages provided based on the one or more techniques described herein, may include, but are not limited to: provision of an improved service-switching technique using PSV records having pre-configured values representing different alternative configurations for processing network traffic, a service-switching system configured to process the PSV records to create DNS records implementing service-switching, a PSV manager configured to allow management of PSV records (enabling creation, searching, and updating of PSV records). Furthermore, benefits of the present disclosure include a novel graphical user interface (GUI) that may be adapted to enable creation of PSV records, management of PSV records, and utilization of PSV records to create DNS records, etc. for developers and/or end users presentable via applications, services, software platforms, and associated computing devices (e.g., user computing devices).

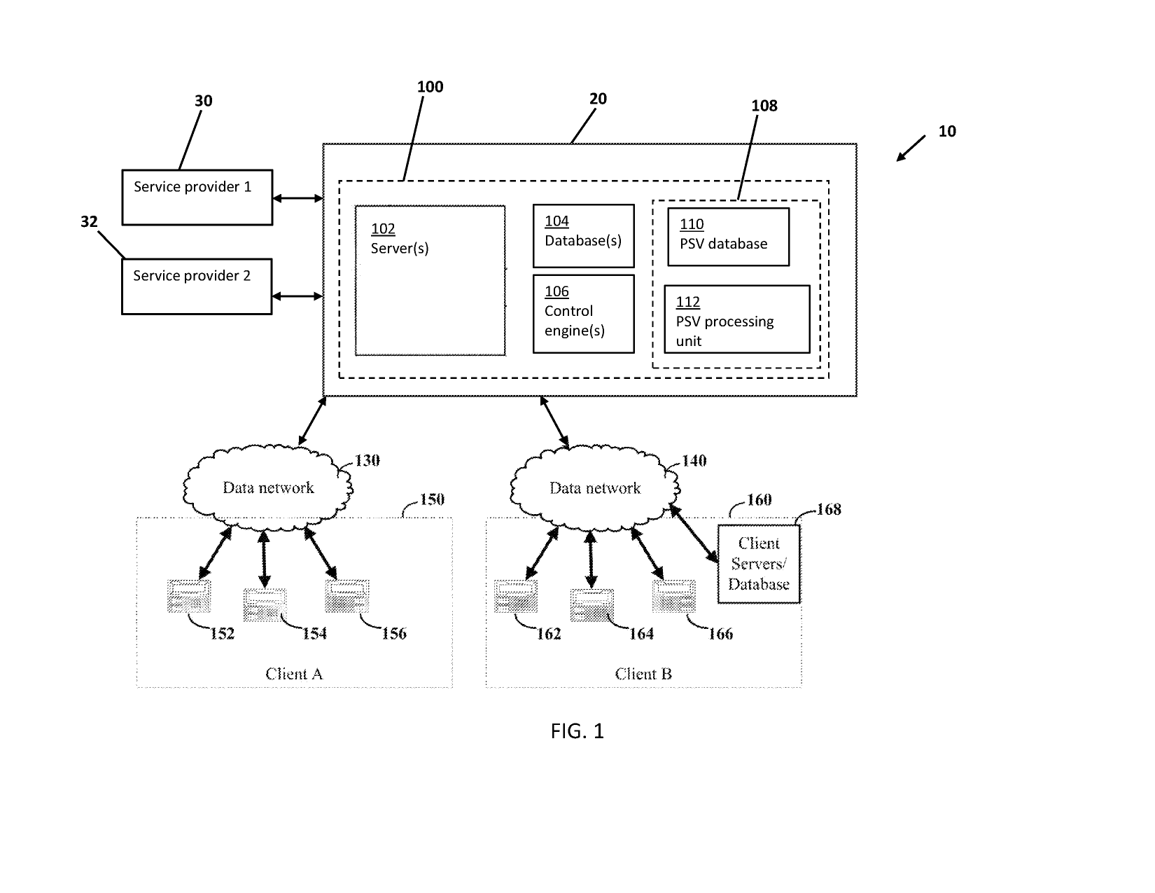

FIG. 1 illustrates an example of a communication system 10 having a contact center 20. The contact center 20 includes a processing system 100 configured to provide one or more features described herein. As shown in the figure, the processing system 100 includes one or more servers 102, one or more databases 104 (e.g., non-transitory medium), and one or more control engines 106. The contact center 20 is configured to provide data communications for a plurality of endpoint devices 152, 154, 156, 162, 164, and 166 connected in one or more data networks 130 and 140. The endpoint devices may include data communications-enabled devices (e.g., IP phones, smart phones, tablets, and/or desktop computers with appropriate data communications software applications) and/or non-data communications endpoint devices (e.g., plain old telephone service (POTS) telephones and cellular-capable devices). Each endpoint device may respectively be associated with an account of a respective client. Endpoint devices may be associated with a particular client account by registering the endpoint device with a particular client account serviced by the contact center 20. Registered devices for each client account may be listed in a respective account settings file (not shown) stored in the database(s) 104. In this example, endpoint devices 152, 154, and 156 are associated within an account 150 for a first client A and endpoint devices 162, 164, and 166 are associated within an account 160 for a second client B. In other cases, any of the endpoint devices may not be associated with any account.

In some cases, the control engine(s) 106 may be one or more client-specific control engine(s) used to facilitate control of endpoint devices associated with a client device. The control of the endpoint devices may be associated with a variety of features including, for example, data communications services such as VoIP calls, audio and/or video conferencing, IPBX exchange servers, packet switching, and traffic management as well as non-data communications services including, but not limited to, website hosting, remote data storage, remote computing services, virtual computing environments. One or more of such features may be provided, for example, by a cloud computing network having one or more servers configurable to provide a data communications system for a plurality of clients. In some cases, the contact center 20 may implement at least a part of such cloud computing network.

The processing system 100 of the contact center 20 includes one or more processing circuits configured to implement the control engine(s) 106, which are configured to adjust the data communications provided for each client account according to a respective set of control directives (e.g., instructions). For instance, the control engine(s) 106 may adjust a manner in which endpoint devices 162, 164, 166 are controlled, and/or a manner of routing of a data communication for a client account, by generating client-specific sets of control data to the server 102. For example, the control engine(s) 106 may generate client-specific sets of control data by processing the respective set of control directives for the account in response to communication event data or other data prompts received at the contact center 20.

Although the control engine(s) 106 is illustrated as a component of the processing system 100 of the contact center 20, the control engine(s) 106 may be implemented in various locations in different embodiments. For example, the control engine(s) 106 for one or more client accounts may be implemented in a central server connected to, or incorporated with, the server(s) 102. Additionally or alternatively, one or more control engine(s) 106 may be implemented by one or more processing circuits maintained by the client (e.g., server/database 168). Similarly, the control directives may be stored locally within the control engines, or stored remotely (e.g., in a centralized database, in a database maintained by the client or a combination thereof).

In some cases, the communication routing and other services for data communications may be provided by the contact center 20 within a cloud service system (e.g., configured to provide virtual features to customers). In such cases, the contact center 20 may include hardware providing the cloud services located in one data center, or a number of different data centers with different physical locations. In some cases, the cloud services may be implemented using SIP servers, media servers, and servers providing other services to both data communications endpoint devices and the users of the data communications endpoint devices. In some instances, the various servers, including both the data communication server(s) and data analytic server(s) discussed herein, may have their functions spread across different physical and logical components. For instance, a cloud-based solution may implement virtual servers that can share common hardware and may be migrated between different underlying hardware. Moreover, in some cases, separate servers or modules may be configured to work together so that they collectively function as a single unified server. Thus, as used in this specification, the term “server” may refer to one or more servers, and may be located at the same facility or in different facilities at different geographical locations.

In some cases, at least one of the server(s) 102 of the contact center 20 may be a data communication server. Such data communication server may use different communication protocols to handle communication functions in different embodiments. For example, such data communication server may use session initiation protocol (SIP) to handle various communication functions (e.g., communication setup and tear down). It should be noted that the server(s) 102 of the contact center 20 is not limited to such example. In other cases, the server(s) 102 may be configured to establish a portion of the communication from the data communications endpoint devices to another data communications endpoint device, or to a gateway. In other cases, the contact center 20 may not include the data communication server. Instead, the contact center 20 may be configured to communicate with the data communication server.

Also, in some cases, at least one of the server(s) 102 of the contact center 20 may be a data analytics server configured to monitor and analyze communication data transmitted between the contact center 20 and endpoint devices, and/or between the contact center 20 and service provider(s) (e.g., service providers 30, 32). For example, a data analytics server may be configured to track communication statistics about various different communication-related parameters, such as communication duration, communication date, communication time of day, called parties, endpoint devices, selected data centers, selected carriers, dropped communications, transferred communications, voicemail access, conferencing features, and others. In other cases, the contact center 20 may not include the data analytics server. Instead, the contact center 20 may be configured to communicate with the data analytics server.

In further cases, the server(s) 102 of the contact center 20 may include a data communication server configured to access communication summary metrics and the data analytics stored in the database(s) 104. For example, a script running the data communications server may parse communication processing XML (CPXML) documents to generate database queries that direct the data communications server to query, or subscribe to, communication length summaries for all communications made to endpoints that are registered to the server. The script may use the information to control how communications are routed as well as how different (customer or provider) services are invoked. In some cases, the server(s) 102 of the contact center 20 may be configured to interface with customer databases, or with third party servers. For instance, a CPXML document stored by in a cloud-based system may identify, based upon a received communication, a Uniform Resource Identifier (URI) that points to customer databases, or to a third-party server. Control directives provided from these servers, for example, in the form of a CPXML document, may be used to specify communication routing, or other functions.

As showing in FIG. 1, the contact center 20 may be configured to communicate with service provider 30 or service provider 32. Each of the service providers 30, 32 may be any third-party provider configured to provide certain services, such as: analytics, data processing, resource, load balancing, API gateway(s), firewall(s), content deliveries, or any of other cloud-based features to assist and/or enhance the data processing capability of the contact center 20, and/or to provide any desired feature(s) for users of the contact center 20. In the illustrated example, the service provider 30 is a first (e.g., primary) service provider configured to provide certain services for the contact center 20, and the service provider 32 is a second (e.g., backup) service provider configured to provide the same or similar services as those of the first service provider 30 in the event of a failure of the first service provider 30.

The switching from the service provider 30 to the service provider 32 in the event of a failure or disaster event is achieved using a preconfigured-selectable-values (PSV) database 110 and a PSV processing unit 112. The PSV database 110 stores PSV records. Each PSV record has a data structure that allows the PSV record to hold multiple values associated with multiple respective service providers. For example, a PSV record stored in the PSV database 110 may include a first value identifying a first IP address of the first service provider 30, and a second value identifying a second IP address of the second service provider 32. The PSV processing unit 112 is configured to access the PSV database 110 to obtain the PSV records in the event of a failure of the service provider 30 or a disaster event that renders the service provider 30 unavailable. For example, the first service provider 30 may be set as the current service provider. However, in the event of a failure of the first service provider 30, the PSV processing unit 112 is configured to obtain from the PSV database 110 the PSV record that is pre-configured to prescribe a switching from the first service provider 30 to the second service provider 32. The PSV processing unit 112 is configured to validate such PSV record, translate the PSV record, and render the PSV record to create a DNS record (a rendered DNS record). The DNS record will have an IP address associated with the second service provider 32, thereby effecting the switching from the first service provider 30 to the second service provider 32. In particular, when the created DNS record is applied to a network traffic infrastructure, it will cause network traffic data to be routed to the newly selected service provider by the network traffic infrastructure according to the created DNS record. The network traffic infrastructure may be one or more processing entities (e.g., an application, the Internet, etc.) that participate in the transmission and/or processing of network traffic data. The network traffic infrastructure may include the contact center 20 in some cases. In other cases, the network traffic infrastructure may include one or more other contact centers, and/or one or more network traffic processing entities that are in communication, either directly or indirectly, with the PSV processing unit 112.

In the illustrated example, the PSV processing unit 112 is illustrated as being a part of the contact center 20. In other cases, the PSV processing unit 112 may be separate from the processing system 100 of the contact center 20. For example, in other cases, the PSV processing unit 112 may be configured to communicate with the processing system 100 of the contact center 20. Thus, the PSV processing unit 112 may or may not be a part of the contact center 20.

Similarly, in the illustrated example, the service-switching system 108 is illustrated as being a part of the contact center 20. In other cases, the service-switching system 108 may be separate from the processing system 100 of the contact center 20. For example, in other cases, the service-switching system 108 may be configured to communicate with the processing system 100 of the contact center 20. Thus, the service-switching system 108 may or may not be a part of the contact center 20. In further cases, the service-switching system 108 may be implemented as a distributed system.

As shown in FIG. 1, the PSV database 110 and the PSV processing unit 112 may be considered as parts of a service-switching system 108. In other cases, the service-switching system 108 may not include the PSV database 110. In such cases, the service-switching system 108 may be configured to communicate with the PSV database 110, which may be a part of the contact center 20, or may be configured to communicate with the contact center 20. Also, in some cases, the PSV database 110 may be integrated with the database(s) 104 of the contact center 20.

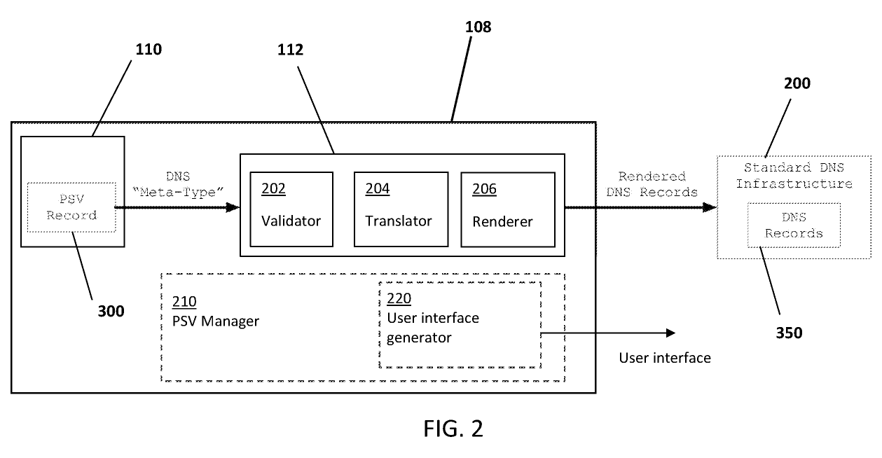

FIG. 2 illustrates the service-switching system 108 of FIG. 1. As shown in the figure, the service-switching system 108 includes the PSV database 110 storing a PSV record 300. The service-switching system 108 also includes the PSV processing unit 112 configured to validate the PSV record 300, translate the PSV record 300 to a translated record, and render the translated record to create a DNS record 350. In the illustrated example, the PSV record 300 has a data structure, and the PSV processing unit 112 has logic that is configured to cooperate with the data structure of the PSV record 300. The DNS record is provided by the service-switching system 108 for application to a network traffic infrastructure 200. In the illustrated example, the PSV processing unit 112 includes a validator 202 configured to validate the PSV record 300 retrieved from the PSV database 110, a translator 204 configured to translate the PSV record 300, and a DNS renderer 206 configured to create the DNS record 350 for application to the network traffic infrastructure 200. Although only one PSV record 300 is shown in the figure, in other cases, the PSV database 110 may store multiple PSV records 300, such as hundred(s), or thousand(s) of PSV records 300.

In some cases, the validator 202 of PSV processing unit 112 may include an identity-and-access manager, or may be configured to communicate and/or integrate with an identity-and-access manager (e.g., a cloud-based identity and access management service such as Okta), to help secure and manage user authentication. In other cases, the identity-and-access manager may be separate from the PSV processing unit 112. In such cases, the PSV processing unit 112 (e.g., the validator therein) may be configured to communicate with the identity-and access manager.

The translator 204 is configured to translate the PSV record to a translated record. The translated record will have information incorporated and/or derived from the PSV record, and such information indicates a desired service provider to be switched to. The DNS renderer 206 is configured to convert the translated record to the appropriate format for the DNS provider. It should be noted that the PSV record has a generic data structure, and therefore is not tied to any specific DNS service provider's requirements. However, after the PSV record is translated, the translated record can be used to generate a DNS configuration that can be used with any DNS service provider. Exemplary DNS service providers are PowerDNS, Bind, Route53, NS1, DNS Made Easy, etc.

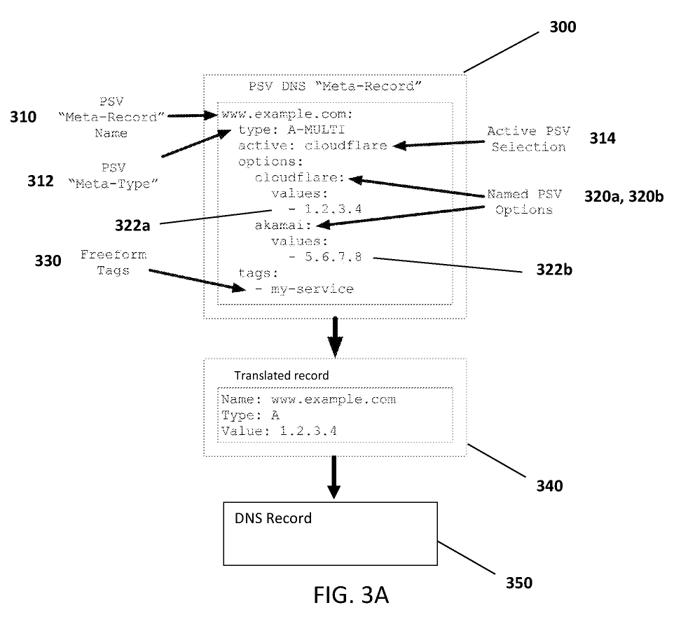

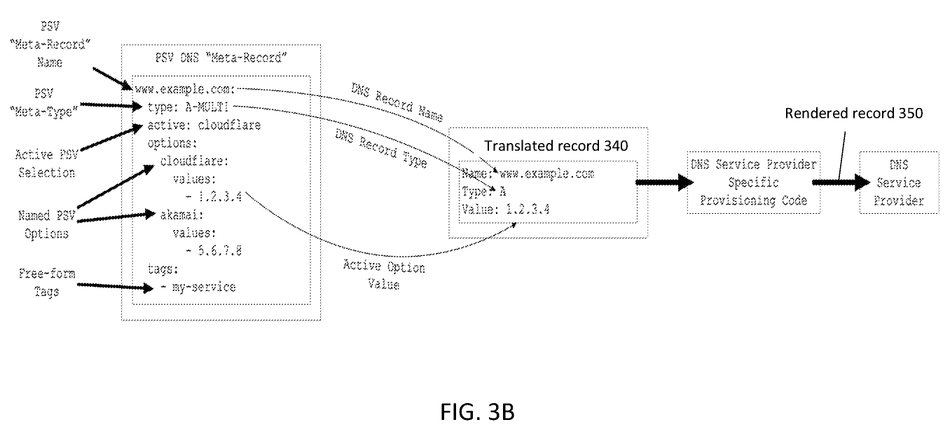

As shown in FIG. 2, in some cases, the service-switching system 108 may optionally include a PSV manager 210. The PSV manager 210 includes a user interface generator 220 configured to provide a user interface for allowing users to create and to configure PSV records, such as the PSV record 300. For example, the user interface may include one or more fields for allowing a user to enter information for the PSV record 300. By means of non-limiting examples, the information for the PSV record may include a name of the PSV record 300, a PSV record type indicator indicating a type of the PSV record 300, an active service provider indicator indicating a currently set service provider prescribed by the PSV record 300, a plurality of service provider identifiers indicating respective service providers that can be switched to utilizing the PSV record 300, a plurality of IP identifiers for the respective service providers, time-to-live value, one or more tags, or two or more of any of the foregoing. The information in the PSV record 300 will be further described with reference to FIGS. 3-5.

The PSV manager 220 is configured to allow one or more users of the service-switching system 108 to manage the PSV records 300 in the PSV database 110. By means of non-limiting examples, the PSV manager 220 may provide a user interface for allowing one or more users to create PSV records, edit PSV records, to delete PSV record, to access PSV database 110, to perform tag-based search on the PSV records, to obtain summarization and reports relating to PSV records, to determine available options related to the PSV records, to perform one or more other functions relating to the PSV records stored in the PSV database 110, or two or more of any of the foregoing.

In some cases, the service-switching system 108 may also include a communication interface (not shown) configured to communicate with one or more processing entities. For example, the communication interface may communicate with one or more contact center components (e.g., server(s) 102, database(s) 104, control engine(s) 106, etc.) of the contact center 20 and/or a component of another contact center. The communication interface may also communicate with one or more third party entities that are separate from the contact center 20.

Also, in some cases, the service-switching system 108 may be configured to provide documentation, tutorials (e.g., tutorial videos), best practices guides, etc., or any combination of the foregoing, for helping users create and/or configure PSV records via the user interface provided by the user interface generator 220 of the PSV processing system 108.

In some cases, the service-switching system 108 may be a part of the data center 20 (like that shown in FIG. 1). In other cases, the service-switching system 108 may be configured to communicatively couple with the data center 20.

It should be noted that any of the components 110, 112, 202, 204, 206, 210, 220 of the service-switching system 208 may be implemented using hardware, software, or a combination of both. Also, two or more of the components 110, 112, 202, 204, 206, 210, 220 may be combined or integrated as one processing unit. In addition, in some cases, the service-switching system 208 may not include the validator 202 and/or the PSV manager 210. Furthermore, one or more of the components 110, 112, 202, 204, 206, 210, 220 may be implemented using a specialized processing unit that is unconventional in the sense that such specialized processing unit may include one or more processing features not present in a generic off-the-shelf computer. Also, in some cases, one or more of the components 110, 112, 202, 204, 206, 210, 220 may be implemented using, or may include, a neural network model.

FIG. 3A illustrates an example of a PSV record 300, and an example of a translated record 340 translated from the PSV record, which can be used to create (e.g., render) a PSV record 350. As shown in FIG. 3A, the PSV record 300 includes a PSV record name 310 for identifying the PSV record 300, a PSV record type (or meta-type) identifier 312, and an active service provider identifier 314. The PSV record 300 also includes a first service provider identifier 320a indicating (e.g., identifying) a first service provider, and a first internet protocol (IP) identifier 322a associated with the first service provider. The PSV record 300 also includes a second service provider identifier 320b indicating (e.g., identifying) a second service provider, and a second IP identifier 322b associated with the second service provider. The active service provider identifier 314 may be selectively set to be the first service provider identifier 320a or the second service provider identifier 320b. The PSV record further includes one or more tags 330, such as one or more free-fom tags.

It should be noted that the term “service provider” may refer to any entity that is capable of receiving network traffic data, and/or that provides a function or a service based on received network traffic data. By means of non-limiting examples, a service provider may be a processing entity, an application, a version of an application, a virtual entity, a server, a software platform, a processor, a cloud-based entity, a storage entity, a website, a host, a virtual machine, a receiving point where network traffic is routed, a department, an organization, a company, any component of a network traffic infrastructure participating in network traffic transmission, etc. Thus, “service provider” is not limited to a company or an organization, and may refer to a physical or virtual processing entity. For example, the PSV record 300 may prescribe a first version of an application and a second version of an application as alternative service providers. In such case, the different versions of the application are considered different “service providers” from a same company or organization. Accordingly, the term “service provider identifier” refers to any information that identifies the service provider, such as any of the above examples of service provider.

The PSV record type (or meta-type) identifier 312 is set as “A-multi” in the illustrated example, indicating that the PSV record 300 has multiple IPv4 records. It should be noted that the PSV record type (or meta-type) identifier 312 is not limited to being set as “A-multi” type indicating IPv4 records. In other cases, the PSV record type (or meta-type) identifier 312 may be set as “AAAA-multi” type indicating that the PSV record 300 has multiple IPv6 records, a “CNAME-multi” type indicating that the PSV record 300 has multiple DNS CNAME records, a “SRV-multi” type indicating that the PSV record 300 has multiple SRV records, a “NS-multi” type indicating that the PSV record 300 has multiple NS records, a “SOA-multi” type indicating that the PSV record 300 has multiple SOA records, a “MX-multi” type indicating that the PSV record 300 has multiple MX records, or any of other Internet-standard DNS types. Thus, each PSV record 300 is associated with a particular Internet-standard DNS type.

The first service provider identifier 320a indicating (e.g., identifying) a first service provider is shown in the example as “cloudflare”, and the second service provider identifier 320b indicating (e.g., identifying) a second service provider is shown in the example as “akamai”. That means the PSV record 300 prescribes “cloudflare” as the first service provider, and “akamai” as the second service provider – both of which are alternative service providers with respect to each other.

The IP identifier (e.g., the first IP identifier 322a, the second IP identifier 322b, etc.) may be an address, a name, a path, or any of other information that identifies a location, a source, an access path, etc., or any of other access information of, or relating to, a corresponding service provider (e.g., first service provider with identifier 320a, or second service provider with identifier 320b). For example, the first IP identifier 322a may be a first IP address of the first service provider, and the second IP identifier 322b may be a second IP address of the second service provider. As another example, the first IP identifier 322a may be a first network path identifier identifying a path to access the first service provider, and the second IP identifier 322b may be a second network path identifier identifying a path to access the second service provider. As a further example, the first IP identifier 322a may be a first name of a first server hosting an application of the first service provider, and the second IP identifier 322b may be a second name of a second server hosting an application of the second service provider.

As shown in the example of FIG. 3A, the active service provider identifier 314 is set as “cloudflare”. Thus, the currently set service provider is “cloudflare”. The PSV processing unit 112 may translate such PSV record 300 into the translated record 340, and utilize such translated record 340 to render a DNS record 350 that includes the IP identifier 322a of the service provider “cloudflare” based on the active service provider identifier 314 currently set in the PSV record 300. Thus, the rendered DNS record 350 has the IP identifier 322a “1.2.3.4” for the service provider “cloudflare” as shown in the example. When the created DNS record 350 is applied to a network traffic infrastructure, it will cause network traffic data to be routed to the newly selected service provider “cloudflare” by the network traffic infrastructure according to the created DNS record with the IP identifiers 322a.

In the event of a failure of the service provider “cloudflare”, the PSV processing unit 112 then retrieves the PSV record 300, updates the PSV record 300 so that the active service provider identifier 314 is set as “akamai”, translates the updated PSV record 300 to a translated record, and renders the translated record to obtain a new DNS record 350 that includes the IP identifier 322b (i.e., 5.6.7.8 in the example) for the service provider “akamai”. When the created DNS record 350 is applied to a network traffic infrastructure, it will cause network traffic data to be routed to the newly selected service provider “akamai” by the network traffic infrastructure according to the created DNS record with the IP identifier 322b.

FIG. 3B illustrates the translation of the PSV record 300 performed by the translator 204, and the rendering of the translated record into a DNS record performed by the renderer 206. The translator 204 is configured to translate the PSV record 300 to a translated record. The translated record will have information incorporated and/or derived from the PSV record 300, and such information indicates a desired service provider to be switched to. The DNS renderer 206 is configured to convert the translated record to the appropriate format for the DNS provider. The PSV record 300 has a generic data structure, and therefore is not tied to any specific DNS service provider's requirements. However, after the PSV record 300 is translated, the translated record can be used to generate a DNS configuration that can be used with any DNS service provider. The PSV record 300 may be considered the source data, which contain the details of which "options" are available, which option is considered "active", and the "values" associated with the active option. Translation is performed to create a translated record indicating a selected option (i.e., the “active” option) in the PSV record 300. Rendering is performed through template that is created for any specific DNS service provider. Specific values from the PSV record are incorporated into the translated record, which is rendered based on DNS service provider-specific code to create the DNS record for the DNS service provider.

It should be noted that the service providers are not limited to “cloudflare” and “akamai”, and that the PSV record 300 may prescribe any of other service providers. Also, in other cases, the service provider identifiers 320a, 320b are not limited to “cloudflare” and “akamai”, and may have other names to indicate different service providers. In another example, the PSV record 300 may prescribe Cloudflare and Fastly as alternative service providers. In another example, the PSV record 300 may prescribe AWS and Oracle Cloud as alternative service providers. In another example, the PSV record 300 may prescribe a first datacenter and a second datacenter as alternative service providers. In another example, the PSV record 300 may prescribe a first disaster recovery provider / scheme / site and a second disaster recovery provider / scheme / site as alternative service providers. In another example, the PSV record 300 may prescribe a first version of an application and a second version of an application as alternative service providers. In another example, the PSV record 300 may prescribe a first server in a company and a second server in a company as alternative service providers.

In some cases, the PSV record 300 may implement disaster recovery in a “service level” disaster recovery scenario and/or in a “global” disaster recovery scenario. At the individual service disaster recovery level, the PSV records 300 may be used by the service-switching system 108 to preconfigure active and disaster recovery sites as named configurations (e.g. "primary_site" and "disaster_site"). During a disaster recovery event, the associated PSV records 300 (grouped based on tags) can be updated in bulk to reflect the desired disaster recovery configuration (e.g., updated by switching the "active" element in each relevant PSV record 300 from "primary_site" to "disaster_site"). This would result in all the associated DNS records 300 pointing to the IP addresses/hostnames associated with the disaster recovery site. At a more global disaster level, public-facing services can be preconfigured with PSV records 300, with one named configuration pointing to service provider "A" (e.g. Cloudflare) and another named configuration pointing to service provider "B" (e.g. Akamai). For example, these may be called "global-cloudflare" and "global-akamai" in the PSV records 300. In the event of a catastrophic Cloudflare issue, all PSV records 300 (obtained by filtering based on tag(s)) associated with Cloudflare may be bulk changed to the "global-akamai" configuration. Since any number of tags can be associated with PSV records 300, the "service level" disaster recovery scenario as well as the "global level" disaster recovery scenario may be supported at the same time by simply including the necessary tag(s) in the PSV records 300 and filtering the PSV records 300 based one or more of the tag(s) selected according to the "scope" of the change desired to be made.

It should be noted that the DNS record 350 is not limited to the above example. A DNS record 350 may be one of several Internet-standard DNS types. By means of non-limiting examples, the type of the DNS record 350 may be A, AAAA, CAS, CNAME, SRV, NS, SOA, MX, etc.

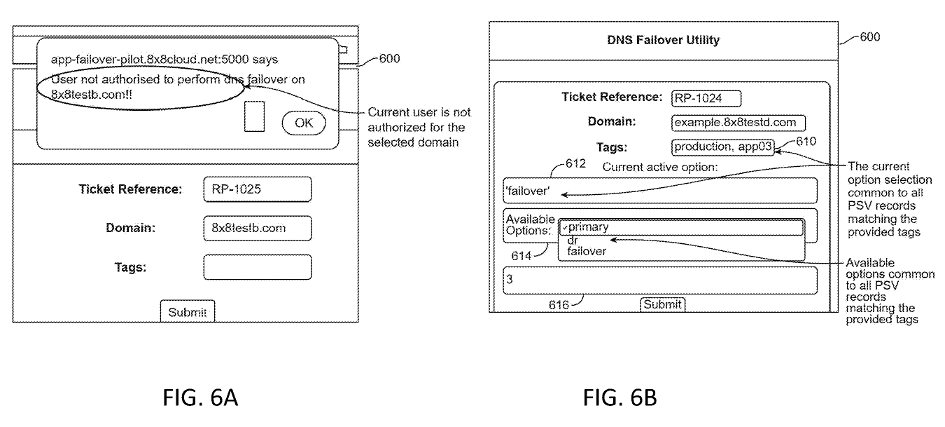

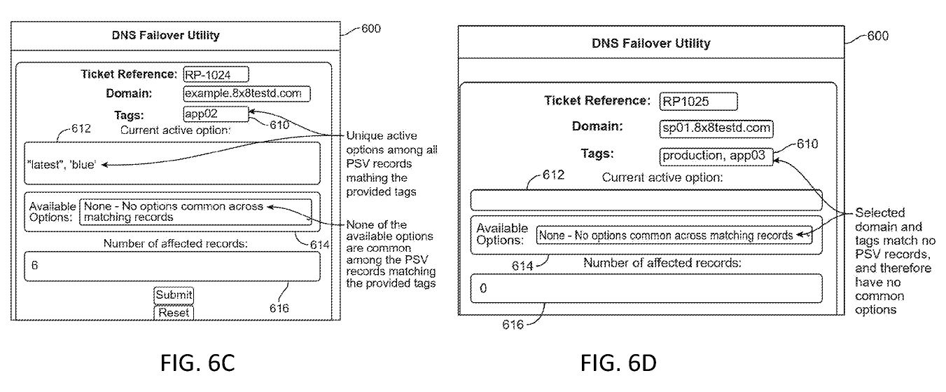

The tag 330 in each PSV record 300 may be an arbitrary string associated with the PSV record 300. Although the PSV record 300 is illustrated as having one tag 330, in other cases, the PSV record 300 may have multiple tags 330. In the PSV database 110, there may be multiple PSV records 300 having respective tag(s) 330. The tags 330 of the PSV records 300 may be utilized to filter and/or select groups or PSV records to update (e.g., via automation or scripting). In some cases, the tag 330 may function as a free-form tag for allowing a user to search for the PSV record 300. As shown in FIG. 3A, the tag 330 in the PSV record 300 is “my-service”. Accordingly, a user may utilize a user interface to enter “my-service” as a tag search term, which will provision a search for all PSV record 300 with such tag 330 in the PSV database 110. An example of such user interface will be described with reference to FIG. 6.

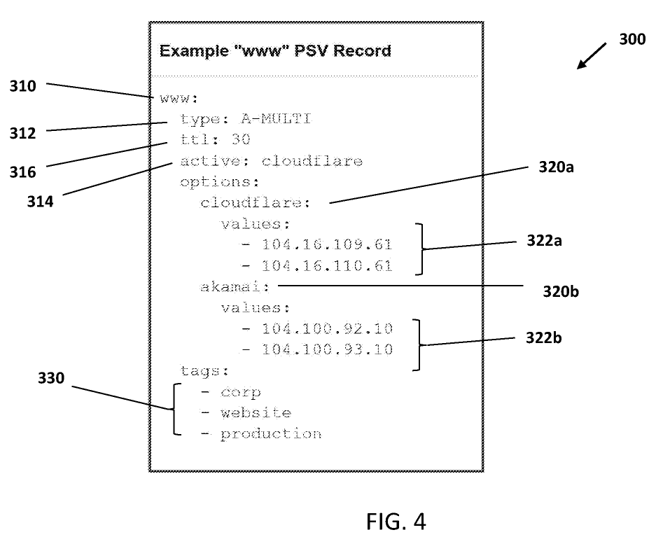

FIG. 4 illustrates another example of a PSV record 300. The PSV record 300 in the example of FIG. 4 includes “www” as the PSV record name 310. In the PSV record 300, the PSV record type 312 is “A-multi” type, indicating that the PSV record has multiple DNS IPv4 records for multiple different respective service providers. In the illustrated example, the PSV record 300 also includes a TTL value 316 of “30”. The time to live (TTL) value in DNS is a number that specifies how long a DNS record can be cached (e.g., by downstream DNS server(s)) before it needs to be refreshed. TTL is measured in seconds. In some cases, the TTL value may be utilized to control how quickly a change to a PSV record will be realized across the Internet. In other cases, the PSV record 300 may not include the TTL value 316. The PSV record 300 also has an active service provider identifier 314 indicating that “cloudflare” is the currently set service provider.

Unlike the example of FIG. 3A, the PSV record of FIG. 4 includes multiple IP identifiers 322a for the first service provider, and multiple IP identifiers 322b for the second service provider. In particular, the IP identifiers 322a are “104.16.109.61” and “104.16.110.61” for the first service provider with the identifier 320a “cloudflare”. The IP identifiers 322b are “104.100.92.10” and “104.100.93.10” for the second service provider with the identifier 320b “akamai”.

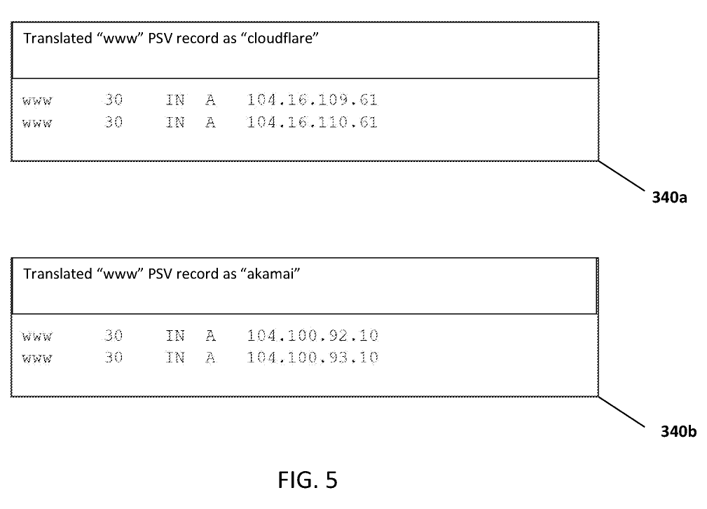

Because the active service provider identifier 314 is set as “cloudflare” (i.e., the identifier 320a of the first service provider), when the PSV processing unit 112 process the PSV record 300 to obtain the translated record 340a, the resulting DNS record based on the translated record 340a will include the IP identifiers 322a “104.16.109.61” and “104.16.110.61” for the first service provider “cloudflare” (see FIG. 5). When the created DNS record is applied to a network traffic infrastructure, it will cause network traffic data to be routed to the service provider “cloudflare” by the network traffic infrastructure according to the created DNS record with the IP identifiers 322a.

In the event of a failure of the service provider “cloudflare”, the PSV processing unit 112 then retrieves the PSV record 300, updates the PSV record 300 so that the active service provider identifier 314 is set as “akamai”, and translate the updated PSV record to obtain a translated record 340b, which may then be rendered into a new DNS record 350 includes the IP identifiers 322b “104.100.92.10” and “104.100.93.10” for the service provider “akamai” (see FIG. 5). When the created DNS record is applied to a network traffic infrastructure, it will cause network traffic data to be routed to the newly selected service provider “akamai” by the network traffic infrastructure according to the created DNS record with the IP identifiers 322b.

As shown in FIG. 4, the tags 330 in the PSV record 300 include “corp”, “website”, and “production”. Accordingly, a user may utilize a user interface to enter “corp”, “website”, “production”, or any combination of the foregoing, as tag search term(s), which will provision a search for the PSV record 300 of FIG. 4 in the PSV database 110. An example of such user interface will be described with reference to FIG. 6.

In the above examples, the PSV processing unit 112 is described as being configured to process the PSV record 300 to create the DNS record 350 in an event of a failure of a service provider. In other cases, the PSV processing unit 112 may be configured to process the PSV record 300 to create the DNS record 350 when other events occur. By means of non-limiting examples, in other cases, the PSV processing unit 112 may be configured to process the PSV record 300 to create the DNS record 350 to implement a service switching when a scheduled time for the service switching has been reached, when a predicted network traffic condition meets a criterion, when an actual network traffic reaches a certain condition, etc. In some cases, the PSV processing unit 112 may be configured to retrieve the PSV record 300, and to process the PSV record 300 to create the DNS record 350 in response to one or more criteria being met. By means of non-limiting examples, the one or more criteria may be for detecting a failure of a service provider, for detecting an actual network traffic condition, for predicting a network traffic condition, for determining whether a scheduled time for a service switching has been reached, etc.

In some cases, the PSV processing unit 112 is configured to automatically process the PSV record 300 to create the DNS record to implement the service switching in response to one or more criteria being met. As described previously, the one or more criteria may be for detecting a failure of a service provider, for detecting an actual network traffic condition, for predicting a network traffic condition, for determining whether a scheduled time for a service switching has been reached, etc.

In other cases, the PSV processing unit 112 is configured to process the PSV record 300 to create the DNS record to implement the service switching in response to receipt of a user input requesting for such service switching. For example, in some cases, when a failure of a service provider occurs, a user of the service-switching system 108 may utilize a user interface provided by the user interface generator 220 to provision a request to the PSV processing unit 112 to cause the PSV processing unit 112 to translate the PSV record, and render the DNS record 350 based on the translated record 340. The rendered DNS record 350 includes the IP identifier of the alternative service provider, and when applied to the network traffic infrastructure, will cause network traffic data to be transmitted to the alternative service provider.

The user of the service-switching system 108 may be an administrator, a member of a disaster recovery team, a programmer, etc. In one implementation of a failover or disaster recovery, a user (e.g., an administrator, a member of a disaster recovery team, etc.) of the service-switching system 108 may utilize the user interface provided by the user interface generator 220 to search for all relevant records in the PSV database 110 using the tag(s) 330. For example, if the failure pertains to a cloud-based financial service, the user may enter “finance” using the user interface to cause the PSV manager 210 to search the PSV database 110 for all PSV records 300 that have “finance” as tags 330. Therefore, the tag(s) 330 allow the user to find all PSV records 300 that have certain tag(s) 330, enabling the user to switch all relevant PSV records 300 based on the tag(s) 330. As described, each PSV record 300 includes a first preconfigured option (i.e., a first service provider) and a second preconfigured option (i.e., a second service provider). Thus, the alternative service providers are pre-configured in advance to implement a future service-switching. Accordingly, the user may utilize the user interface to update the active elements in all of the relevant PSV records 300 from one preconfigured option to the other preconfigured option. In some cases, the user interface may allow the user to update all of the active elements together (e.g., in one batch). This feature is advantageous because it allows large scale change to be made. For example, this feature may allow the user to update tens, hundreds, and thousands of PSV records 300 all together. After all relevant PSV records 300 are updated, the translator 204 of the PSV processing unit 112 then translates the updated PSV records to a translated record 340, and the renderer 206 of the PSV processing unit 112 then renders the translated records 340 into standard DNS records 350 for directing network traffic.

It should be noted that the tag 330 (e.g., free-fom tag) is not limited to the above examples, and that the PSV record 300 may include other tag(s) 330. Also, the PSV record 300 may have any number of tag(s) 330. In some cases, the tags 330 may be very granular or may have different granularity to allow different levels of search for relevant PSV records 300 to be performed.

FIGS. 6A-6D illustrate examples of a user interfaces 600 provided by the PSV manager 210 in different scenarios during use of the PSV manager 210 to search for relevant PSV records 300 in the PSV database 110, and to configure the PSV records 300. As shown in the FIG. 6A, after a user logs into the service-switching system 208 using the user interface provided by the PSV manager 210, and after the identity of the user has been verified by the PSV manager 210, the user interface 600a may allow the user to enter a tick reference value and a domain. If the user is not authorized for the domain, then the user interface 600a may provide a message to inform the user of such.

As shown in FIG. 6B, after the identity of the user has been verified, and after the user has been verified as having authorization for the entered domain, the user interface 600 may allow the user to search the PSV database 110 for one or more PSV records that satisfy the requirements entered by the user. As shown in the figure, the user has entered “production” and “app03” in the “Tags” search field 610 of the user interface 600. Based on such input, the PSV manager 210 of the PSV processing unit 112 searches the PSV database 100 to determine how many PSV records 300 have tags 330 that match the user’s input (i.e., “production” and “app03”) in the “Tags” search field. In the illustrated example, the PSV manager 210 returns a number of “3” in the quantity field 616, indicating that there are 3 PSV records 300 that have the tags “production” and “app03”. This means that each of the 3 PSV records has both “production” and “app03” tags. The user interface 600 provided by the PSV manager 210 also indicate in the currently set option field 612 of the user interface 600 that all of the PSV records 300 matching the entered tag(s) are currently set to the option “failover”. In some cases, the PSV manager 210 is configured to identify all of the active service provider identifiers 314 in the PSV records 300 matching the entered tag(s), determine which one(s) of the active service provider identifiers 314 is common to all of the PSV records 300 matching the entered tag(s), and list the common active service provider identifier(s) 314 in the currently set option field 612. The “available options” field 614 of the user interface 600b indicates that all 3 PSV records have the available options “primary”, “dr”, and “failover”. In one implementation, the PSV manager 210 is configured to identify all service provider identifiers 320 in the PSV records 300 matching the entered tag(s), determine which one(s) of the service provider identifiers 320 is common to all of the PSV records 300 matching the entered tag(s), and provide the common one(s) in the “available options” field 614 for the user to select. In some cases, if the user selects “primary” in the “available options” filed 614, the PSV manager 210 will change all 3 affected PSV records 300 so that their currently set option becomes “primary” (i.e., so that the active service provider identifiers 314 in the PSV records 300 are set to “primary”), thereby changing the active service provider identifiers 314 in the 3 PSV records 300 from “failover” to “primary”. After the 3 PSV records 300 have been configured, the PSV processing unit 112 may then process the 3 PSV records 300 to render respective DNS records 350 for application to the network traffic infrastructure.

FIG. 6C illustrates a scenario that is different from that of FIG. 6B. As shown in FIG. 6C, the user enters “app02” in the “tags” search field 610. The PSV manager 210 then searches the PSV database 110 to determine how many PSV records 300 have such a tag, and returns a number of “6” in the quantity field 616, indicating that there are 6 PSV records with the tag 330 “app02”. The currently set option field 612 indicates that the 6 PSV records 300 matching the tag “app02” currently have “latest” and “blue” as their active service provider identifiers 314, which means that one or more of the 6 PSV records are set to prescribe the “latest” service provider, and other(s) is set to prescribe “blue” service provider. The “available options” field 614 shows that the 6 PSV records 300 do not have any option that is commonly available. That means the 6 PSV records 300 do not have any service provider indicator 320 that is in common. As a result, the user in this scenario cannot configure all 6 of the PSV records 300 together.

FIG. 6D illustrates another scenario. As shown in FIG. 6D, the user enters “production” and “app03” in the “tags” search field 610. The PSV manager 210 then searches the PSV database 110 to determine how many PSV records 300 have such tags, and returns a number of “0” in the quantity field 616, indicating that there are no PSV records with both the tags 330 “production” and “app03”. The currently set option field 612 does not provide any result because there is no PSV records that match the search term(s) entered by the user. The “available options” field 614 shows that there is no available option that is in common because there is no PSV records that match the search term(s).

The user interface 600 is not limited to the above examples, and may have other configurations, and may provide other features, in other cases. For example, in other cases, the user interface 600 may allow the user to entered structured search terms in the “Tags” search field 610, which provides more flexibility for the user to perform complex searches. For example, the user may enter “and”, “or”, “not”, “>”, “<”, etc. in the “Tags’ search field 610 for allowing the PSV manager 210 to perform Boolean searches.

It should be noted that the PSV record 300 described herein is not limited to the examples described, and that the PSV record 300 may have other configurations and/or features in other cases. For example, in some cases, instead of having two service provider indicators 320a, 320b, and associated IP identifiers 322a, 322b, the PSV record 300 may have more than two service provider indicators 320 (e.g., three, four, five, six, etc. service provider indictors 320), and each service provider indicator 320 may have one or more corresponding IP identifier(s) 322.

Also, in other cases, the PSV record 300 may be configured to implement a vendor-agnostic DNS configuration. Also, in some cases, the PSV record 300 may be translated and rendered into any format compatible with any DNS vendor / provider. For example, the PSV record 300 may be translated by the translator 204 of the PSV processing unit 112 and rendered by the renderer 206 to a format compatible with AWS Route53. In the event of a change (e.g., change of business relationship with a new cloud provider), the same PSV record 300 may be translated and rendered to a format compatible with the new cloud provider (e.g., Microsoft Azure).

The PSV record 300 described herein is not limited to being utilized for failover and disaster recovery. The PSV record 300 may support a wide variety of DNS use-cases. The PSV record 300 is a meta-type custom configuration construct that enables multiple named configurations to be associated with a DNS record.

Also, in other cases, instead of updating the PSV record 300 for generating new DNS record in response to disaster recovery, the updating of the PSV record 300 and the rendering of the DNS record may be performed based on a satisfaction of one or more criterion, and/or based on input from an algorithm (e.g., independent algorithm), such as an input from an AI model, an input from a scheduler, or any other input or trigger.

For example, in other cases, the PSV records 300 may be utilized by data centers to manage DNS-driven mechanisms utilized by the data centers. Data centers may implement various DNS-driven mechanisms to manage application traffic into the data centers and service providers. These solutions range from custom user-interface driven tools, to complex shell scripts and programs. These tools may be application-specific and may be difficult to maintain. Also, ongoing support of these tools may be difficult as they may require a deep understanding of DNS, limitations and intricacies of the infrastructure supporting the tools, and intimate understanding of the application-specific logic and terminology. As a result, these tools may be tightly-coupled with infrastructure, inhibiting independent maintenance and upgrades of the infrastructure. The PSV record 300 described herein provide an abstraction or intermediate layer for allowing data centers to manage DNS-driven mechanisms.

As another example, in other cases, the PSV records 300 may be utilized by the service-switching system 108 to configure routing of traffic between data centers. PSV records 300 may be grouped using the tag(s) 330. These can include tags representing the service name, environment (e.g. "production", "staging", etc.), and data center. Using the tags 330, services associated with a particular application, environment, and data center (e.g., by filtering on "pbx" and "production" and "sv2" tags 330) can be filtered/selected for bulk update. In one scenario, several named configurations in the PSV records 300 are preconfigured, representing the endpoints where network traffic for the selected records will be routed. By changing the "active" element on these PSV records 300 from "sv2" to "dc6", for example, network traffic can be routed from one data center to another data center.

### Advantages

As illustrated in the above example, the service-switching system 108 described herein is advantageous because it allows any number of PSV records 300 (meta-records) to be pre-configured with selectable values (e.g., service provider identifiers, IP identifiers, etc.), which can be used to “swing” traffic between two or more entities, such as data centers, cloud service providers, etc. This is advantageous because without the PSV record 300, deployment code (and sometimes the application code) would need to be modified in order to support the new DNS provider. The PSV record 300 obviates the need to change the code that creates and/or deletes DNS record, and also obviates the need to update and reformat DNS data in order to support new service provider.

Also, the tags 330 described herein allow all relevant PSV records 300 to be searched for, making large-scale changes to DNS repeatable, testable, and simple. The DNS records 350 created based on the PSV records 300 may apply to any combination of services, applications, versions, providers, etc.

### Method

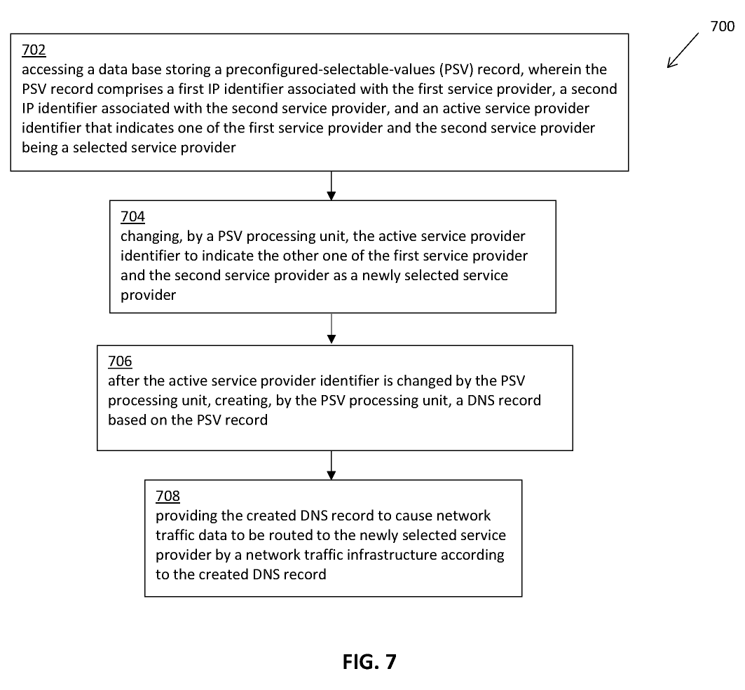

FIG. 7 illustrates a method 700 in accordance with some embodiments. In some cases, the method 700 may be performed by the service-switching system 108 described with reference to FIGS. 1-2. In other cases, the method 700 may be performed by other system(s). The method 700 includes: accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider (item 702); changing, by a PSV processing unit, the active service provider identifier to indicate the other one of the first service provider and the second service provider as a newly selected service provider (item 704); after the active service provider identifier is changed by the PSV processing unit, creating, by the PSV processing unit, a DNS record based on the PSV record (item 706); and providing the created DNS record to cause network traffic data to be routed to the newly selected service provider by a network traffic infrastructure according to the created DNS record (item 708).

Optionally, in the method 700, the DNS record is created based on the changed active service provider identifier in the PSV record.

Optionally, in the method 700, the act of creating the DNS record by the PSV processing unit comprises translating the PSV record, and rendering the translated PSV record.

Optionally, in the method 700, the DNS record is created to implement the service switching when there is a failure of one of the first and second service providers.

Optionally, in the method 700, the DNS record is created to implement the service switching in response to a scheduled service switching.

Optionally, in the method 700, the DNS record is created to implement the service switching when a predicted network traffic condition meets a criterion.

Optionally, in the method 700, the DNS record is created to implement the service switching when an actual network traffic condition meets a criterion.

Optionally, in the method 700, the PSV record comprises one or more tags, wherein the method 700 further comprises searching, by the PSV processing unit, for the PSV record using the one or more tags of the PSV record.

Optionally, in the method 700, the PSV record is one of a plurality of PSV records stored in the PSV database, and the method 700 includes searching the PSV database to identify one or more of the PSV records with respective tag(s) that match a search criterion.

Optionally, in the method 700, the one or more of the PSV records comprises multiple ones of the PSV records having respective tags matching the search criterion, the multiple ones of the PSV records having respective active service provider identifiers, and the method 700 comprises change the respective active service provider identifiers of the multiple ones of the PSV records in one batch.

Optionally, in the method 700, the PSV record comprises a meta-type identifier.

Optionally, in the method 700, the meta-type identifier comprises an A-multi type indicating that the PSV record has multiple DNS IPv4 records, an AAAA-multi type indicating that the PSV record has multiple IPv6 records, a CNAME-multi type indicating that the PSV record has multiple DNS CNAME records, or a SRV-multi type indicating that the PSV record has multiple DNS SRV records.

Optionally, in the method 700, the PSV record further comprises a time-to-live (TTL) value.

Optionally, in the method 700, the PSV processing unit comprises logic that cooperate with a data structure of the PSV record.

Optionally, the method 700 is performed by a system that is integrated with a contact center, or is configured to communicate with the contact center, the system having the PSV processing unit.

Optionally, the method 700 further includes providing a user interface that allows a user of the system to create the PSV record.

Optionally, the method 700 further includes providing a PSV manager configured to allow a user of the system to manage the PSV record.

Optionally, in the method 700, the PSV record comprises one or more tags to provide a context to influence an artificial intelligence (AI) driven workflow.

Optionally, in the method 700, the PSV record is configured to implement a vendor-agnostic DNS configuration.

Optionally, the method 700 may be implemented using a product having a non-transitory medium storing a set of instructions, wherein an execution of the instructions will cause the method to be performed. The method 700 implemented using the product includes: accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider; changing, by a PSV processing unit, the active service provider identifier to indicate the other one of the first service provider and the second service provider as a newly selected service provider; after the active service provider identifier is changed by the PSV processing unit, creating, by the PSV processing unit, a DNS record based on the PSV record; and providing the created DNS record to cause network traffic data to be routed to the newly selected service provider by a network traffic infrastructure according to the created DNS record. In some cases, the set of instructions may include instructions for accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider. The set of instructions may also include instructions for changing the active service provider identifier to indicate the other one of the first service provider and the second service provider as a newly selected service provider. The set of instructions may also include instructions for, after the active service provider identifier is changed, creating a DNS record based on the PSV record. The set of instructions may also include instructions for providing the created DNS record to cause network traffic data to be routed to the newly selected service provider by a network traffic infrastructure according to the created DNS record.

### Neural network implementation

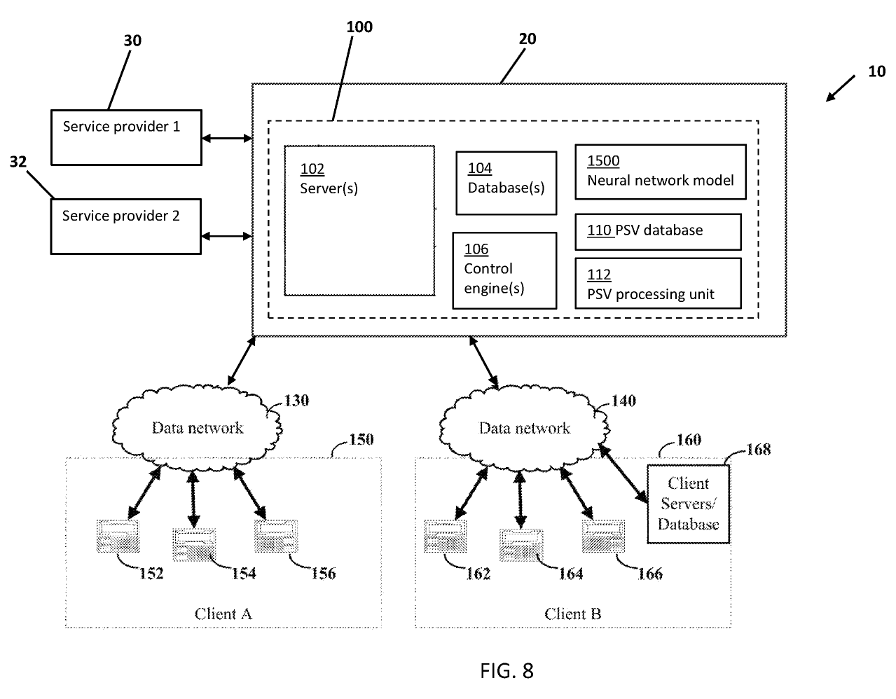

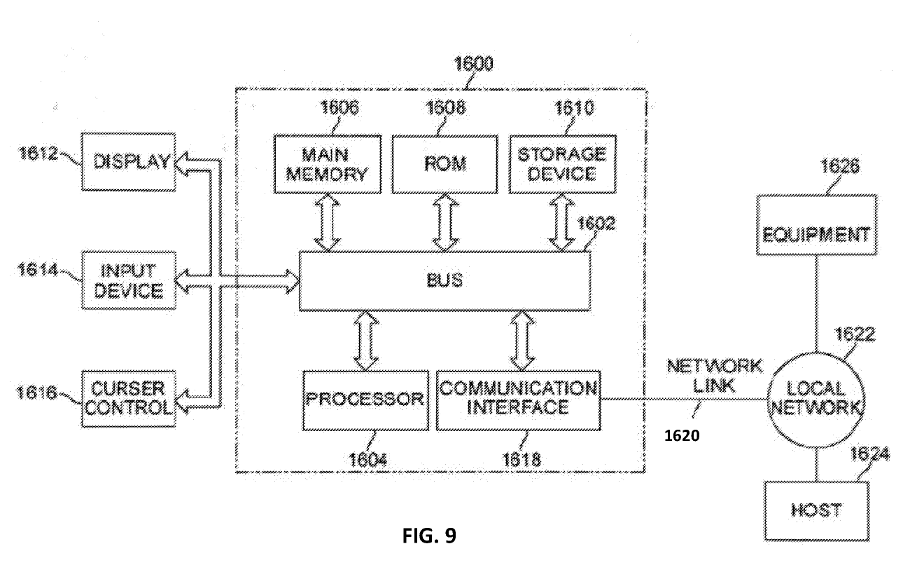

Moreover, aspects of the present disclosure are directed to systems and methods that implement neural network model. FIG. 8 illustrates a communication system 10 that is the same as that described with reference to FIG. 1, particularly showing the processing system 100 having a neural network model 1500. By means of non-limiting examples, the neural network model 1500 may be trained artificial intelligence (AI), machine learning (ML), etc. The neural network model 1500 may implement, or may be at least a part of the system 100. In some cases, the neural network model 1500 may be a part of the service-switching system 108 described herein. In other cases, the neural network model 1500 may be in communication with the system 100 or the service-switching system 108. The neural network model 1500 may be a part of the data center 20, or may be separate from the data center 20.

In some cases, the neural network model 1500 may be configured to receive and use one or more of a variety of data involved in network traffic flow as input, perform analysis based on such data to monitor network traffic and/or services involved with the network traffic, and provide output based on the analysis. The output from the neural network model 1500 may be insight data regarding the state of the network traffic flow and/or insight data regarding the state of one or more services involved with the network traffic flow. In some cases, the output from the neural network model 1500 may be a recommendation to perform service-switching, in which cases, the service-switching system 108 described herein may be utilized to process PSV records 300 to affect the service-switching. The service-switching may be based on the tags 330 in the PSV records, as described herein. Thus, in some cases, the tags 330 in the PSV records 300 may be used to provide a context to influence AI-driven workflow. In other cases, the output from the neural network model 1500 may be provided as input automatically to control the service-switching system 108, so that a service-switching can be automatically executed. Furthermore, in some cases, the neural network model 1500 may provide recommendations of services and applications that benefit from a time-of-day (e.g., recommendation to switch-service if an alternative service provider has more bandwidth at a certain time of the day). The neural network model 1500 may be configured to perform predictive analysis, or configured to receive result of a predictive analysis. In such cases, the neural network model 1500 may preemptively switch service provider, or may recommend the switching of the service provider, ahead of a predicted congestion event. In addition, in some cases, the neural network model 1500 may be configured to provide recommendation to switch service provider based on traffic optimization, cost minimization, etc. (e.g., by determining least-cost routing switch between providers to optimize traffic and/or to minimize cost). Also, in some cases, the neural network model 1500 may detect abnormal condition in network traffic, or may receive output from an anormally detection system. In such cases, the neural network model 1500 may provide recommendation to switch service provider if abnormal condition in the network traffic is detected.

In some cases, the neural network model 1500 may provide neural network processing to further contemplate various types of signal data that may be collected through various host applications/services (e.g., pertaining to a software communications platform). In some cases, the neural network model 1500 may identify a potential issue with network traffic (such as a potential issue with a service involved with network traffic data) based on such signal data. For instance, application of trained AI/ML processing (e.g., one or more trained machine learning models) may be adapted to evaluate network traffic processed by an exemplary software platform (e.g., software communications platform such as 8x8 Work®), and/or network traffic to and/or from third party service providers. Contextual data can be derived from any data point individually or in aggregation including historical signal data or current signal data (e.g., an ongoing communication such as an electronic meeting). For example, historical signal data collected using a software communications platform, including from prior user communications, can be combined with current user-specific signal data, device-specific signal data, etc., prior, during or after an electronic communication, to generate and surface contextually relevant data insights for a user (e.g., a member of a disaster recovery team, an agent assisting a customer and/or in different omni-channel communication experiences across a software communications platform, etc.). This unique and comprehensive analysis of big data managed through a software communications platform enables provision of rich and contextually relevant data insights tailored for a specific purpose (e.g., to identify whether a service-switching criterion has been met, such as to identify whether an actual failure of a service provider has occurred, whether a potential failure of a service provider is about to occur, whether a load-balancing criterion has been met, etc.). Exemplary signal data analysis can further be utilized to yield determinations as to how (and/or when) to generate updated analytics (in real-time or near real-time) and/or reporting, as well as when and how often to present data insights and/or suggestions (e.g., suggestion to implement a service-switching using PSV records 300 described herein). In further examples, signal data can be analyzed to determine the next steps or actions (e.g., service-switching) to be performed to continue communication and user engagement across a plurality of communication channels of a software communications platform (e.g., omni-channel communication experience). Non-limiting examples of signal data that may be collected and analyzed includes but is not limited to: device-specific signal data collected from operation of one or more user computing devices; user-specific signal data collected from specific tenants/user-accounts with respect to access to any of: devices, login to a distributed software platform, applications, services, etc.; application-specific data collected from usage of applications/services and associated endpoints (including third-party endpoints integrated within a software platform), data collected from disparate software platforms that provide disparate types of access characteristics; data collected from data flow architecture including integrated service (e.g., bots) in a software communications platform, or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., software communications platforms), where target users may be developers, engineers, end users, or customers, and where telemetric analysis may be applied to generate determinations with respect to a contextual state of any type of user activity with respect to different host application/services and associated endpoints at any point in time (historic, current, or predictive of future). Analysis of signal data, including user-specific signal data, should occur in compliance with user privacy regulations and policies.

In some examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI, ML modeling. Trained AI processing may be adapted to execute specific determinations described herein including those for analyzing specific data and data sources of a software data platform (e.g., a software communications platform) and/or generating insights for management of data flows, GUI feature functionality, or data augmentation. For instance, an AI model may be specifically trained and adapted for execution of processing operations pertaining to analyzing features and functionality of a software communications platform including those non-limiting examples described herein. Non-limiting examples of AI implementation including but are not limited to: analyzing data (and metadata) associated with one or more software platforms including third-party integrations of features/functionalities; analyzing data of past, current or scheduled communications, among other examples.

In one example, trained AI processing comprises a hybrid AI model (e.g., hybrid machine learning model, neural network model) that is adapted and trained to execute a plurality of processing operations described in the present disclosure. In alternative examples, trained AI processing comprises a collective application of a plurality of trained AI models (e.g., 3 trained AI models) that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to work within a software communications platform including data, data sources, and integrations (e.g., APIs, web hooks, etc.) related to features and functionality provided (or extending capabilities) of a software communications platform. In examples where a plurality of independently trained and managed AI models is implemented, downstream processing efficiency may be improved by an ordered application of trained AI models where processing results from earlier applied AI models can be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise but are not limited to: nearest neighbor processing; naive Bayes classification processing; decision trees; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, etc.; application of association rule learning; application of latent variable modeling; anomaly detection; and neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise but are not limited to: value-based processing; policy-based processing; and model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI/ML processing.

Further, aspects may integrate AI/ML modeling to correlate large volumes of data in a contextually relevant manner. This can be used not only for generation (and adaptation) of scoring for types of data to surface but also generation of decision points (e.g., alerting, access control, next steps, omni-channel engagement) as well as generation of data insights/suggestions, reporting, generation of knowledge base, support content, data processing flow configuration recommendations (e.g., recommendation to perform service-switching). In addition to broad applicability, approaches according to the present disclosure can be implemented as a scalable solution (e.g., a solution for a company in several different use cases are built (such as department-specific or user group-specific) to more effectively manage a software platform (e.g. communications software platform).

As an example, one or more ML/AI models may be generated, trained and adapted to analyze context of network traffic flow, for example, to identify potential or actual failure of a service provider involved in the network traffic flow.

In additional examples, AI/ML modeling may be built, trained, and adapted to manage insight generation and layers of abstraction including ranking and relevance. For instance, contextual analysis of data interactions relative to the plurality of data endpoints for an exemplary software communications platform can selectively generate insights specific to interested parties (such as disaster recovery team, product/engineering, etc.) data insights that are specific to end users, and data insights, that are specific to others including third-party vendors. Generated insights can be ranked for relevance and propagated accordingly for one or more interested parties, for example, aligning with organizational specifications. For example, in some cases, an insight may be generated for a disaster recovery team to address a potential issue with a processing flow that has relevance to a service provider. In such cases, the disaster recovery team may want to utilize the service-switching system 108 described herein to address the potential issue.

### Specialized Processing System

FIG. 9 illustrates a specialized processing system 1600 for implementing one or more features described herein. For examples, the processing system 1600 may implement the system 100, or one or more components of the system 100 (such as the service-switching system 108, the PSV database, the PSV processing unit, etc.).

Processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processor system 1600 may be coupled via the bus 1602 to a display 1612, such as a screen or a flat panel, for displaying information to a user. An input device 1614, including alphanumeric and other keys, or a touchscreen, and/or any of other data capture devices (sensors), is coupled to the bus 1602 for communicating information and command selections to processor 1604. Another type of user input device is cursor control 1616, such as a 2D touchpad, a touchscreen, a trackball, or cursor direction keys for communicating direction information and command selections to processor 1604 and/or for controlling cursor movement on display 1612. This input device typically has two degrees of freedom in two axes, a first axis (e.g., x) and a second axis (e.g., y), that allows the device to specify positions in a plane. The input device 1614 and/or the cursor control device 1616 may be the same device in some embodiments. Also, the input device 1614 and/or the cursor control device 1616 may be any 2D input device or 3D input device.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term "processor-readable medium" as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, SD disks, such as the storage device 1610. A non-volatile medium may be considered an example of non-transitory medium. Volatile media includes dynamic memory, such as the main memory 1606. A volatile medium may be considered an example of non-transitory medium. Transmission media includes cables, wire and fiber optics, including the wires that comprise the bus 1602. Transmission media can also take the form of acoustic or light waves, such as those generated during radio wave and infrared data communications.

Common forms of processor-readable media include, for example, hard disk, a magnetic medium, a CD-ROM, any other optical medium, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a storage of a remote computer or remote device. The remote computer or device can send the instructions over a network, such as the Internet. A receiving unit local to the processing system 1600 can receive the data from the network, and provide the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card to provide a data communication. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

In some cases, the processing system 1600 may be configured as a specialized processing system using instructions and/or programming language to cause electronic components of the processing system 1600 to behave in certain unique manner in order to provide one or more technical features described herein.

Also, in some cases, one or more of the actions (e.g., accessing a database, changing an active service provider identifier, creating a DNS record, providing the created DNS record, etc.) described herein as being performed by the service-switching system 108 are performed electronically. Therefore, they are not mental process and are not abstract idea. In addition, the PSV record described herein, as well as the DNS record created based on the PSV record, result in physical transformation in the real world. This is because the PSV record is configured to implement a switching of service that will otherwise not occur. The DNS record created based on the PSV record is configured to cause a network traffic infrastructure to route network traffic data to a newly selected service provider, which will otherwise not occur.

### Cloud-based platform implementation

It should be noted that the system 100 (e.g., the service-switching system 108 therein) and/or the contact center 20 described herein may be implemented as, or may be a part of, any platform(s), such as one or more cloud-based platforms. By means of non-limiting examples, the one or more cloud-based platforms may include an Unified Communications as a Service (UCaas) platform, a Control Center as a Service (CCaas) platform, a Communications Platform as a Service (CPaas), or any combination of two or more of the foregoing.

UCaaS is a cloud-based solution that integrates various communication tools and services, including voice calls, video conferencing, messaging, and collaboration features into a single platform. It aims to simplify and unify communications within an organization, enabling employees to connect seamlessly across different devices and locations. UCaaS platforms may provide tools for voice over IP (VoIP), instant messaging, file sharing, video calls, and even presence management. By leveraging the cloud, businesses can scale their communication infrastructure without needing on-premise hardware, and remote or hybrid teams can communicate as easily as if they were in the same office.

CCaaS refers to a cloud-based platform that provides businesses with the tools to manage and optimize their customer service and support operations. It may include features like automatic call distribution (ACD), interactive voice response (IVR), call recording, omnichannel support (electronic meetings, voice, chat, email, messaging, digital messaging, social media), and analytics. CCaaS solutions are designed to improve customer experiences by streamlining communication with support agents and offering deeper insights into customer interactions. They also allow organizations to scale their contact centers efficiently, adapting to peak periods or shifting team sizes. This service is particularly beneficial for businesses with high customer interaction volumes, such as retail, finance, and telecom.

CPaaS is a cloud-based service that provides developers with the tools and APIs to integrate real-time communication capabilities into their own applications, websites, or workflows. Unlike UCaaS and CCaaS, which are pre-built solutions, CPaaS offers a flexible, customizable platform that can be tailored to the specific needs of an organization. With CPaaS, businesses can embed voice, video, messaging, and even chatbots into their applications without having to build complex communication infrastructure from scratch. This makes CPaaS ideal for organizations looking to create bespoke customer engagement solutions or integrate communication features into existing platforms, such as e-commerce websites or CRM systems.

In other cases, the system 200 and/or the contact center 20 described herein may be implemented as, or may be a part of, other types of cloud-based platforms, such as a Customer Experience as a Service (CXaaS) platform, an Infrastructure-as-a-Service (IaaS) platform, Platform-as-a-Service (PaaS), a Software-as-a-Service (SaaS) platform, or Anything-as-a-Service (xPaas) platform.

CXaaS is a cloud-based model that provides businesses with on-demand tools and services to manage and enhance their customer experience (CX) across various touchpoints. It integrates a wide range of solutions—such as customer service platforms, analytics, feedback management, and communication channels—into a unified service offering. CXaaS allows organizations to deliver personalized, omnichannel experiences for customers without having to invest in complex, on-premise systems. By leveraging cloud technology, businesses can easily scale their CX capabilities, gain insights from data analytics, and continuously improve interactions with customers, ultimately boosting satisfaction and loyalty. CXaaS empowers companies to respond more agilely to changing customer expectations while reducing the overhead of maintaining and upgrading traditional customer experience infrastructure.

IaaS is a cloud computing model that provides virtualized computing resources over the internet, such as servers, storage, networking, and other infrastructure components, on a pay-as-you-go basis. Instead of investing in and maintaining physical hardware, businesses can rent infrastructure from a cloud service provider, allowing them to scale resources up or down based on demand. IaaS offers flexibility, cost-efficiency, and the ability to focus on application development and business operations rather than IT management. With IaaS, businesses can deploy and manage applications without the need for physical data centers, significantly reducing capital expenditures and operational complexity.

PaaS is a cloud computing model that provides a comprehensive platform allowing developers to build, deploy, and manage applications without needing to manage the underlying infrastructure. It offers a set of tools, frameworks, and services—such as databases, development environments, and middleware—built on top of IaaS (Infrastructure-as-a-Service), enabling businesses to focus on writing code and developing functionality rather than worrying about the hardware, network, or operating system. PaaS platforms typically support multiple programming languages and integrate with various third-party services, allowing for greater flexibility and speed in application development. By abstracting away infrastructure concerns, PaaS empowers developers to innovate and scale applications quickly, improving productivity and reducing time-to-market for new features or products.

SaaS is a cloud computing model that delivers software applications over the internet on a subscription or pay-as-you-go basis, eliminating the need for businesses to install, maintain, or update software on their own servers or devices. With SaaS, users can access applications from any device with an internet connection, typically through a web browser, making it highly convenient and scalable. SaaS providers handle all aspects of the software, including updates, security, and infrastructure management, freeing businesses from the complexities of software maintenance. This model is particularly advantageous for businesses because it reduces upfront costs, supports remote collaboration, and ensures that users are always using the most up-to-date version of the software.

xPaaS is an expansive cloud service model that offers a wide range of customizable, on-demand capabilities across various domains, such as infrastructure, software, and platforms, enabling businesses to access specialized services without the need for extensive on-site management. Unlike traditional cloud models like IaaS, PaaS, or SaaS, xPaaS can encompass almost any type of service or functionality a business may require, from data analytics and artificial intelligence to security, IoT, and application deployment. This flexibility allows organizations to tailor solutions to their unique needs, scale resources dynamically, and innovate faster while minimizing upfront costs and complexity. xPaaS simplifies operations by providing a unified, cloud-based platform for diverse business functions, making it an appealing option for organizations seeking agility and cost efficiency in a rapidly changing digital landscape.

### Definitions

As used in this specification, the term “product” may refer to any human-made and/or machine-made article/item. By means of non-limiting examples, the product may be an electronic device, a hardware and/or software component of an electronic device, an application in a cloud / server, etc.

As used in this specification, the term “contact center” refers to any communication system or component(s) thereof, which handles communications between or among parties via phone, SMS, email, web, cloud, social media, or any combination of the foregoing, wherein a party may be a customer, an organization, a chatbot, or any of other types of entity that is capable of communicating with an individual.

In addition, as used in this specification, the term “neural network model” refers to any computing unit, system, or module made up of a number of interconnected processing elements, which process information by their dynamic state response to input. In some embodiments, the neural network model may have deep learning capability, machine learning capability, and/or artificial intelligence. In some embodiments, the neural network model may be simply any computing element that can be trained using one or more data sets. Also, in some embodiments, the neural network model may be any type of neural network. By means of non-limiting examples, the neural network model may be a perceptron, a feedforward neural network, a radial basis neural network, a deep-feed forward neural network, a recurrent neural network, a long/short term memory neural network, a gated recurrent unit, an auto encoder neural network, a variational auto encoder neural network, a denoising auto encoder neural network, a sparse auto encoder neural network, a Markov chain neural network, a Hopfield neural network, a Boltzmann machine, a restricted Boltzmann machine, a deep belief network, a convolutional network, a deconvolutional network, a deep convolutional inverse graphics network, a generative adversarial network, a liquid state machine, an extreme learning machine, an echo state network, a deep residual network, a Kohonen network, a support vector machine, a neural turing machine, a modular neural network, a sequence-to-sequence model, etc., or any combination of the foregoing.

In addition, as used in this specification, the term “model” may refer to one or more algorithms, one or more equations, one or more processing applications, one or more variables, one or more criteria, one or more parameters, or any combination of two or more of the foregoing. Also, the term “model” may in some embodiments cover machine learning model (such as neural network model), or components thereof, such as layers, interconnections weights, or any combination of the foregoing.

Also, as used in this specification, the term “machine learning model” may refer to any processing entity (e.g., module, application, program, processing architecture, etc.) that has machine learning capability and/or that is configured by machine learning. Neural network model is an example of machine learning model, and therefore, the term “machine learning model” is not limited to neural network model.

Also, as used in this specification, the term “signal” may refer to one or more signals. By means of non-limiting examples, a signal may include one or more data, one or more information, one or more signal values, one or more discrete values, etc.

The following items pertains to one or more embodiments or features described herein:

Item 1. A system configured to implement a service switching between a first service provider and a second service provider, the system comprising:

a PSV processing unit configured to communicate with a database;

the data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider;

wherein the processing unit is configured to access the database to retrieve the PSV record;

wherein the PSV processing unit is configured to change the active service provider identifier to indicate the other one of the first service provider and the second service provider as a newly selected service provider;

wherein the PSV processing unit is configured to, after changing the active service provider identifier in the PSV record, process the PSV record to create a DNS record, and to provide the created DNS record to cause network traffic data to be routed to the newly selected service provider by a network traffic infrastructure according to the created DNS record.

Item 2. The system of Item 1, wherein the created the DNS record is based on the changed active service provider identifier in the PSV record.

Item 3. The system of Item 1, wherein the PSV processing unit is configured to create the DNS record by translating the PSV record, and rendering the translated PSV record.

Item 4. The system of Item 1, wherein the PSV processing unit is configured to process the PSV record to create the DNS record to implement the service switching when there is a failure of one of the first and second service providers.

Item 5. The system of Item 1, wherein the PSV processing unit is configured to process the PSV record to create the DNS record to implement the service switching in response to a scheduled service switching.

Item 6. The system of Item 1, wherein the PSV processing unit is configured to process the PSV record to create the DNS record to implement the service switching when a predicted network traffic condition meets a criterion.

Item 7. The system of Item 1, wherein the PSV processing unit is configured to process the PSV record to create the DNS record to implement the service switching when an actual network traffic condition meets a criterion.

Item 8. The system of Item 1, wherein the PSV record further comprises one or more tags, and wherein the PSV processing unit is configured to search for the PSV record using the one or more tags of the PSV record.

Item 9. The system of Item 1, wherein the PSV record is one of a plurality of PSV records stored in the PSV database, and wherein the PSV processing unit is configured to search the PSV database to identify one or more of the PSV records with respective tag(s) that match a search criterion.

Item 10. The system of Item 9, wherein the one or more of the PSV records comprises multiple ones of the PSV records having respective tags matching the search criterion, the multiple ones of the PSV records having respective active service provider identifiers, and wherein the PSV processing unit is configured to change the respective active service provider identifiers of the multiple ones of the PSV records in one batch.

Item 11. The system of Item 1, wherein the PSV record further comprises a meta-type identifier.

Item 12. The system of Item 11, wherein the meta-type identifier comprises an A-multi type indicating that the PSV record has multiple DNS IPv4 records, an AAAA-multi type indicating that the PSV record has multiple IPv6 records, a CNAME-multi type indicating that the PSV record has multiple DNS CNAME records, or a SRV-multi type indicating that the PSV record has multiple DNS SRV records.

Item 13. The system of Item 1, wherein the PSV record further comprises a time-to-live (TTL) value.

Item 14. The system of Item 1, wherein the PSV processing unit comprises logic that cooperate with a data structure of the PSV record.

Item 15. The system of Item 1, wherein the system is integrated with a contact center, or is configured to communicate with the contact center.

Item 16. The system of Item 1, wherein the PSV processing unit comprises a PSV configurator configured to provide a user interface that allows a user of the system to create the PSV record.

Item 17. The system of c Item 1, wherein the PSV processing unit comprises a PSV manager configured to allow a user of the system to manage the PSV record.

Item 18. The system of Item 1, wherein the PSV record comprises one or more tags to provide a context to influence an artificial intelligence (AI) driven workflow.

Item 19. The system of Item 1, wherein the PSV record is configured to implement a vendor-agnostic DNS configuration.

Item 20. A method to implement service switching between a first service provider and a second service provider, the method comprising:

accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider;

changing, by a PSV processing unit, the active service provider identifier to indicate the other one of the first service provider and the second service provider as a newly selected service provider;

after the active service provider identifier is changed by the PSV processing unit, creating, by the PSV processing unit, a DNS record based on the PSV record; and

providing the created DNS record to cause network traffic data to be routed to the newly selected service provider by a network traffic infrastructure according to the created DNS record.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

What is claimed is:

1. A system configured to implement a service switching between a first service provider and a second service provider, the system comprising:
a PSV processing unit configured to communicate with a database;
the data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider;
wherein the processing unit is configured to access the database to retrieve the PSV record;
wherein the PSV processing unit is configured to change the active service provider identifier to indicate the other one of the first service provider and the second service provider as a newly selected service provider;
wherein the PSV processing unit is configured to, after changing the active service provider identifier in the PSV record, process the PSV record to create a DNS record, and to provide the created DNS record to cause network traffic data to be routed to the newly selected service provider by a network traffic infrastructure according to the created DNS record.

2. The system of claim 1, wherein the created the DNS record is based on the changed active service provider identifier in the PSV record.

3. The system of claim 1, wherein the PSV processing unit is configured to create the DNS record by translating the PSV record, and rendering the translated PSV record.

4. The system of claim 1, wherein the PSV processing unit is configured to process the PSV record to create the DNS record to implement the service switching when there is a failure of one of the first and second service providers.

5. The system of claim 1, wherein the PSV processing unit is configured to process the PSV record to create the DNS record to implement the service switching in response to a scheduled service switching.

6. The system of claim 1, wherein the PSV processing unit is configured to process the PSV record to create the DNS record to implement the service switching when a predicted network traffic condition meets a criterion.

7. The system of claim 1, wherein the PSV processing unit is configured to process the PSV record to create the DNS record to implement the service switching when an actual network traffic condition meets a criterion.

8. The system of claim 1, wherein the PSV record further comprises one or more tags, and wherein the PSV processing unit is configured to search for the PSV record using the one or more tags of the PSV record.

9. The system of claim 1, wherein the PSV record is one of a plurality of PSV records stored in the PSV database, and wherein the PSV processing unit is configured to search the PSV database to identify one or more of the PSV records with respective tag(s) that match a search criterion.

10. The system of claim 9, wherein the one or more of the PSV records comprises multiple ones of the PSV records having respective tags matching the search criterion, the multiple ones of the PSV records having respective active service provider identifiers, and wherein the PSV processing unit is configured to change the respective active service provider identifiers of the multiple ones of the PSV records in one batch.

11. The system of claim 1, wherein the PSV record further comprises a meta-type identifier.

12. The system of claim 11, wherein the meta-type identifier comprises an A-multi type indicating that the PSV record has multiple DNS IPv4 records, an AAAA-multi type indicating that the PSV record has multiple IPv6 records, a CNAME-multi type indicating that the PSV record has multiple DNS CNAME records, or a SRV-multi type indicating that the PSV record has multiple DNS SRV records.

13. The system of claim 1, wherein the PSV record further comprises a time-to-live (TTL) value.

14. The system of claim 1, wherein the PSV processing unit comprises logic that cooperate with a data structure of the PSV record.

15. The system of claim 1, wherein the system is integrated with a contact center, or is configured to communicate with the contact center.

16. The system of claim 1, wherein the PSV processing unit comprises a PSV configurator configured to provide a user interface that allows a user of the system to create the PSV record.

17. The system of claim 1, wherein the PSV processing unit comprises a PSV manager configured to allow a user of the system to manage the PSV record.

18. The system of claim 1, wherein the PSV record comprises one or more tags to provide a context to influence an artificial intelligence (AI) driven workflow.

19. The system of claim 1, wherein the PSV record is configured to implement a vendor-agnostic DNS configuration.

20. A method to implement service switching between a first service provider and a second service provider, the method comprising:
accessing a data base storing a preconfigured-selectable-values (PSV) record, wherein the PSV record comprises a first IP identifier associated with the first service provider, a second IP identifier associated with the second service provider, and an active service provider identifier that indicates one of the first service provider and the second service provider being a selected service provider;
changing, by a PSV processing unit, the active service provider identifier to indicate the other one of the first service provider and the second service provider as a newly selected service provider;
after the active service provider identifier is changed by the PSV processing unit, creating, by the PSV processing unit, a DNS record based on the PSV record; and
providing the created DNS record to cause network traffic data to be routed to the newly selected service provider by a network traffic infrastructure according to the created DNS record.
